(19) United States
(12) Patent Application Publication
(10) Pub. No.: US 2026/0348215 A1
(43) Pub. Date: Nov. 5, 2026

(54) ITEM OF FURNITURE COMPRISING AN ELECTRIC AND MECHANICAL DRIVE UNIT

(71) Applicant: Julius Blum GmbH, Hoechst (AT)

(72) Inventors: Wolfgang BOHLE, Goetzis (AT); André Hammerer, Alberschwende (AT)

(21) Appl. No.: 19/713,043

(22) Filed: Jun. 18, 2026

Related U.S. Application Data
(63) Continuation of application No. PCT/AT2024/060457, filed on Nov. 21, 2024.

(30) Foreign Application Priority Data
Dec. 21, 2023 (AT) A 51040/2023

(51) Int. Cl. E05D 15/58; E05F 15/605; E05F 15/635

(52) U.S. Cl. CPC E05D 15/581; E05F 15/605; E05F 15/635; E05Y 2900/212

(57) ABSTRACT

A piece of furniture includes a furniture body, a door arrangement for covering the furniture body in a closed position, a receiving shaft arranged laterally of the furniture body, and an electric drive device for applying force to the door arrangement. The door arrangement is movable by the electric drive device between a closed position and an open position and/or between an open position and a retracted position in the receiving shaft. A mechanical drive device and/or a hinge force accumulator for spreading the folding door and/or a folding sliding door are also provided. The door arrangement is movable by the mechanical drive device between the closed position and the open position and/or between the open position and the retracted position. The electric drive device and the mechanical drive device are arranged between two planes spanned by the receiving shaft and parallel to a side wall of the furniture body.

This application is a continuation of International Application No. PCT/AT2024/060457, filed on Nov. 21, 2024. Thus, all of the subject matter of International Application No. PCT/AT2024/060457 is incorporated herein by reference.

### BACKGROUND OF THE INVENTION

The invention relates to a piece of furniture comprising:
a furniture body,
at least one door arrangement comprising a hinged door, preferably pivotable about an axis vertical in the operating position of the piece of furniture, a folding door and/or a folding sliding door, for at least partially covering the furniture body, preferably an interior space of the furniture body defined by the furniture body, in a closed position of the at least one door arrangement,
a receiving shaft arranged laterally to the furniture body, in which the at least one door arrangement can be moved, at least in regions, into a retracted position,
at least one electric drive device for applying force to the at least one door arrangement, wherein the at least one door arrangement is movable by the at least one electric drive device at least in regions between a closed position and an open position and/or between an open position and a position retracted into the receiving shaft, and
at least one mechanical drive device, preferably an ejection device for ejecting the at least one door arrangement from the receiving shaft and/or a hinge force accumulator for spreading the folding door and/or sliding door, wherein the at least one door arrangement is movable by the at least one mechanical drive device at least in regions between the closed position and the open position and/or between the open position and the retracted position.

A piece of furniture in which a rope of a mechanical rope drive device is arranged over balls on a support of a door arrangement to assist in extending a support from a receiving shaft is already known from DE 20 2020 107 104 U1.

A disadvantage of the prior art is that the rope can only transmit translational movement and only in one direction relative to the receiving shaft. All further movement trajectories of the door arrangement must be performed manually. Furthermore, manual force application is required to move the door arrangement.

### SUMMARY OF THE INVENTION

The objective technical object of the present invention is therefore to provide a piece of furniture which is improved compared to the prior art, in which the disadvantages of the prior art are at least partially eliminated, and which is characterized in particular by a lean design, a particularly comfortable operation and/or a user-friendly assembly.

It is thus provided according to the invention, that the at least one electric drive device and the at least one mechanical drive device are arranged at least in the retracted position between two planes spanned by the receiving shaft and oriented parallel to a side wall of the furniture body, preferably within the receiving shaft.

This makes it possible for all drive means for the movement of the at least one door arrangement to be mounted in the region of the receiving shaft.

In addition, there is the positive feature that no adaptations need to be made to the furniture body for retrofitting a furniture body with movement mechanisms, or that necessary adjustments can be limited to the receiving shaft or the door arrangement located in the region of the receiving shaft.

The receiving shaft can be provided, for example, by an external space to the side of the furniture body or by an internal space within the furniture body-for example laterally adjacent to a side wall of the piece of furniture.

Preferably, the piece of furniture has at least one rope drive device, wherein the at least one rope drive device comprises the at least one drive device and at least one rope that can be acted upon with a force by the at least one drive device, wherein the at least one rope is arranged or can be arranged on the at least one door arrangement in such a way that the at least one door arrangement can be moved via the at least one rope drive device.

This makes it possible for the at least one door arrangement to be moved fully automatically between the closed position and the open position and/or a retracted position next to or inside the furniture body and the open position in a user-friendly manner after activation of the at least one rope drive device.

It is preferable that the hinged door, folding door and/or folding sliding door is arranged, preferably via a hinge band, on a support and/or at least one carriage of the at least one door arrangement, wherein it is preferably provided that the at least one carriage is movable laterally next to the furniture body along a first guide rail between the open position and the closed position and/or the support is movable laterally next to the furniture body along a second guide rail, preferably arranged orthogonally to the first guide rail, between the open position and a retracted position.

The at least one carriage can act in a dual function, wherein the movement of the at least one door arrangement along the second guide rail is only released when an end position is reached along a first guide rail, in order to ensure that the at least one door arrangement can be properly inserted into the receiving shaft. Blocking the insertion movement into the receiving shaft can also be achieved when using a hinged door, for example by blocking the transition into the receiving shaft until the rotation has ended. Alternatively or additionally, a force-controlled locking for the insertion movement can be provided, in that the at least one door arrangement is pre-tensioned from the receiving shaft in the direction of the open position and only in the parallel position of the at least one door arrangement to the receiving shaft does the force of the (electric) drive device overcome this pre-tension force to move into the receiving shaft. The force-controlled locking is preferably achieved through a reduction gear.

Preferably, the receiving shaft comprises at least one ejection device for ejecting the at least one door arrangement in the direction of the open position, wherein an ejection force accumulator of the at least one ejection device can be loaded by the movement of the at least one door arrangement in the direction of the retracted position mediated by the at least one electrical drive device.

The automatic charging process of the ejection device eliminates the need for a manual power supply to the ejection mechanism.

It is preferable that the at least one drive device is arranged stationary, preferably in a rear region of the receiving shaft, within the receiving shaft and/or is movement-coupled with the at least one door arrangement, preferably an optional support.

Particularly preferred, the at least one drive device is attached to the support, which makes mounting the at least one drive device easier. However, the at least one drive device (and any coupling gear that may be present) can also be attached, for example, to the first guide rail and/or to the furniture body and/or to a front end of the receiving shaft. For example, the at least one drive device can be used as an add-on for retrofitting existing movement technologies of the piece of furniture, wherein, for example, an interface for the at least one drive device can be arranged on the support and/or in a receiving shaft.

If at least one drive device is arranged on the support, a retraction movement of the at least one door arrangement can be accomplished, for example, by connecting a rope to a rear region of the receiving shaft or by deflecting the rope on a pulley at the rear region of the receiving shaft, wherein movements without a rope are also possible—for example, by means of a coupling gear or a rack.

Preferably, the at least one door arrangement is movable via the at least one electric drive device
starting from an open position or a partially retracted position in the direction of a retracted position, preferably up to the retracted position, and/or
starting from the retracted position or the partially retracted position in the direction of the open position, preferably up to the open position.

This allows the same drive device to handle both the movement transverse to the front of the furniture body and along the receiving shaft, thus reducing the number of drive concepts.

It is preferable that at least one deflection device for the at least one rope is arranged on the furniture body, preferably on a guide rail that may be present, and/or in the receiving shaft.

By means of at least one deflection device—in particular at least one deflection roller—the at least one drive device can be stored in a concealed manner by a support at the rear in the receiving shaft and/or arranged at a suitable position on the furniture body and still generate a force transmission to a free end of the at least one door arrangement in order to move in particular an entire travel distance of the at least one door arrangement with electrical or stored mechanical energy without manual operation or a jerky ejection movement.

Preferably, the at least one rope is guided through the at least one deflection device in a loop (without a free end), so that, depending on the direction of rotation, a closing movement or an opening movement of the at least one door arrangement—preferably via at least one coupling gear—can be mediated via the at least one drive device.

Preferably, the at least one rope is arranged on the at least one carriage and/or the at least one carriage comprises at least one pivot lever, wherein the at least one pivot lever is pivotably arranged on the at least one carriage and can be brought into contact with the at least one door arrangement.

A dead center position in the closed position can be bridged by using the at least one pivot lever. Overcoming the dead center position—for example via an ejection device or by manual operation—is not necessary due to the interaction between the at least one pivot lever and the at least one door arrangement.

It is preferable that the at least one rope is arranged on the at least one pivot lever, wherein it is preferably provided that a pivoting movement of the at least one pivot lever is limited by the at least one carriage, preferably by a stop arranged on the at least one carriage and/or in the range between 5° and 15° of the door arrangement opening angle.

Limiting the pivoting range prevents the rope drive device from running freely in connection with the movement of the at least one door arrangement. The abutment can be achieved, for example, by a pin.

It is preferable that the at least one drive device can be activated by a switch, preferably arranged on the furniture body or on the at least one door arrangement, preferably by overriding movement of the at least one door arrangement in the closed position and/or by contacting or capacitively.

The at least one switch allows the operator of the piece of furniture to automatically forward an opening or closing request to the at least one drive device. The switch can be activated by contact with at least one door arrangement and/or by operation via an operator of the piece of furniture, the switch being located, for example, on a furniture side wall and/or a horizontally oriented furniture panel and/or on a remote control.

Preferably, the at least one door arrangement is fully foldable and/or collapsible or pliable and/or collapsible between the closed position and the open position by means of the at least one electric drive device, and/or the at least one door arrangement comprises a folding door and/or folding sliding door, wherein the folding door and/or folding sliding door comprises a hinge, wherein the hinge connects the door leaves of the folding door or folding sliding door to one another and comprises a hinge force accumulator to support movement of the at least one door arrangement in the direction of the closed position, wherein the hinge force accumulator can be loaded by movement of the at least one door arrangement in the direction of the open position mediated by the at least one electric drive device.

The automatic charging process of the hinge force accumulator eliminates the need for a closing mechanism of at least one door arrangement to be manually supplied with energy during the opening movement.

It is preferable that the at least one electric drive device is arranged on at least one coupling gear that is spatially separate from the at least one electric drive device.

In the context of the present invention, the technical term coupling gear can be defined as a component connecting the at least one electrical or mechanical drive device with the at least one door arrangement, which converts drive energy into a pivoting or rotational movement of the at least one door arrangement. Gears and/or a transmission are generally not absolutely necessary.

The at least one coupling gear can comprise a pivot arm for transmitting the pivoting movement of the at least one coupling gear to the at least one door arrangement, which, for example, engages a support hinge (for connecting a door leaf to the support) and/or, preferably directly, the hinged door, folding door and/or folding sliding door.

The at least one coupling gear can be considered as part of the at least one drive device and/or as part of the at least one door arrangement.

However, the at least one drive device does not need to be connected to the coupling gear. For example, the coupling gear can have its own drive device, preferably electric.

The at least one coupling gear can act as a link between the at least one (preferably electric) drive device and the at least one door arrangement, wherein the at least one coupling gear can alternatively or additionally be driven via a rack in conjunction with a gear. For example, the rack or gear can be provided for a bidirectional movement of the at least one door arrangement within the receiving shaft, wherein the at least one mechanical or electrical drive device provides for a folding or flipping operation of the at least one door arrangement.

It is preferable that the at least one electric drive device is arranged via the at least one coupling gear, preferably via a profile rail arranged on the at least one door arrangement, on the at least one door arrangement and/or the support, preferably the hinge band, and/or at least one support hinge.

Forces can be transmitted in a bidirectional direction from the at least one coupling gear via a profile rail, so that the at least one door arrangement can be moved by a pulling action in both the closed and open positions.

Particularly preferred is the arrangement of at least one coupling gear on the support in a movement-coupled manner with the support.

The at least one coupling gear can generally also be arranged on the furniture body, preferably on the first guide rail. Preferably, the at least one coupling gear is arranged at least predominantly on the support.

Preferably, the at least one rope drive device comprises at least one pulley for reducing a force acting from the at least one rope on the at least one door arrangement.

Preferably, the at least one rope drive device comprises at least one pulley for reducing a force acting from the at least one rope on the at least one door arrangement.

The force transmitted by the at least one rope drive device can be reduced by at least one pulley due to an increase in the length of the rope used for force transmission for the movement of at least one door arrangement. It is particularly preferred that the force be at least halved and/or limited to a maximum of 50 N by means of at least one pulley.

### BRIEF DESCRIPTION OF THE DRAWINGS

Further details and advantages of the present invention will be explained in more detail below with reference to the drawings, in which:

FIGS. 1a-1c show a piece of furniture according to a preferred embodiment with a folding sliding door in three different positions in perspective view,

FIG. 2 shows the component parts of the folding sliding door of the piece of furniture involved in the movement technology according to the exemplary embodiment according to FIG. 1a in perspective view with enlarged detail sections,

FIGS. 3a-3c show a carriage, a switch and a deflection device for the movement technology according to the exemplary embodiment according to FIG. 2 in enlarged view,

FIGS. 4a-6b show the piece of furniture according to the exemplary embodiment according to FIG. 1a each in a top view and an enlarged detail view in the region of the carriage in different positions starting from a closed position of the folding sliding door in the direction of an open position,

FIGS. 7a, 7b show a piece of furniture according to a further preferred embodiment with a hinged door in a top view and with an enlarged detail section in the region of a coupling gear of a rope drive device,

FIGS. 8a, 8b show the component parts of the hinged door of the piece of furniture involved in the movement technology according to the exemplary embodiment shown in FIG. 7b in perspective views,

FIGS. 9a, 9b show a coupling gear for a rope drive device for moving the hinged door of the piece of furniture according to the exemplary embodiment shown in FIG. 7b in perspective view,

FIGS. 10a-10f are schematic representations of possible arrangements of a rope drive device relative to a door arrangement in different positions of the door arrangement,

FIGS. 11a-11d show a rope drive device according to a preferred exemplary embodiment with a pulley for reducing a rope force,

FIG. 12 shows a movement device for moving a support along a receiving shaft.

### DETAILED DESCRIPTION OF THE INVENTION

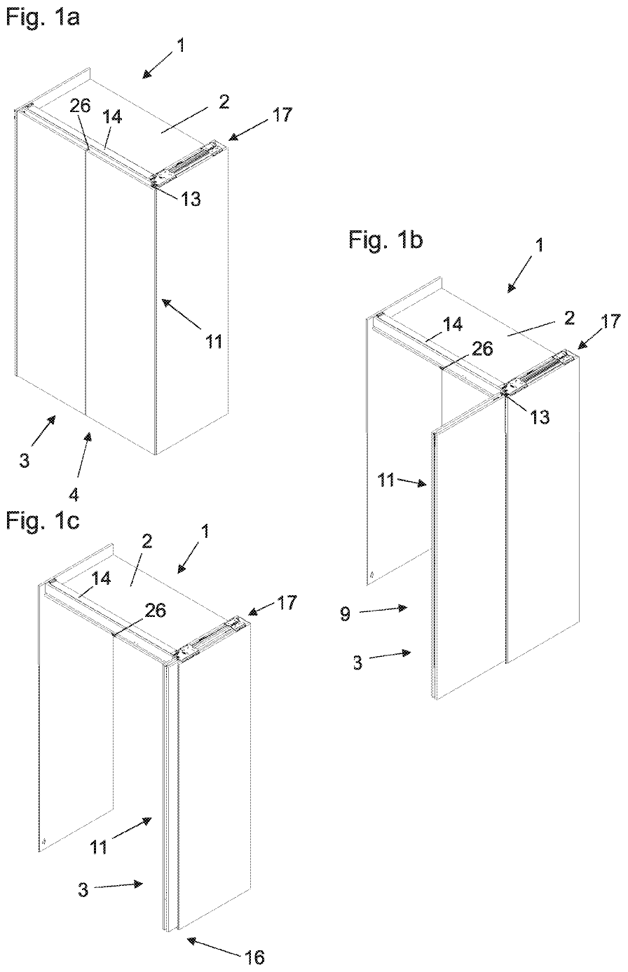

FIG. 1a shows a piece of furniture 1, comprising a furniture body 2, a door arrangement 3 with a folding sliding door 11 for covering the furniture body 2 or other piece of furniture located therein in a closed position 4 of the door arrangement 3 and a rope drive device 5, which in the illustration is concealed by a receiving shaft 17 arranged laterally next to the furniture body 2 and a panel of a first guide rail 14. Alternatively or in addition to the folding sliding door 11, a hinged door 10 or a folding door may be provided.
FIG. 1b differs from FIG. 1a only in that the door arrangement 3 was moved from the closed position 4 to an open position 9 by a translational movement of a carriage 22 along the first guide rail 14. A folding door generally does not require coupling with a carriage 22.
FIG. 1c differs from FIG. 1b only in that the door arrangement 3 was moved from the open position 9 into a retracted position 16 in the receiving shaft 17 by a translational movement. The door arrangement 3 can be moved between the open position 9 and a retracted position 16 within the receiving shaft 17 by means of the rope drive device 5.

The arrangement comprises a mechanical drive device in the form of an ejection device 18 for ejecting the door arrangement 3 from the receiving shaft 17 and a hinge force accumulator 30 for spreading the folding sliding door 11, wherein the door arrangement 3 is movable by the mechanical drive device between the closed position 4 and the open position 9 and between the open position 9 and the retracted position 16. If a hinged door 10 is provided, a hinge force accumulator 30 is generally not required.

The electric drive device 6 and the mechanical drive device are arranged in the retracted position 16 between two planes spanned by the receiving shaft 17 and oriented parallel to a side wall of the furniture body 2. The ejection device 18 and electric drive device 6 are arranged inside the receiving shaft 17.

Starting from the closed position 4, the door arrangement 3 can be moved by the electric drive device 6 between the closed position 4 and the retracted position 16. Starting from the retracted position 16, the door arrangement 3 can be moved between the retracted position 16 and the closed position 4 by means of the mechanical drive device.

The door arrangement 3 can be moved between the retracted position 16 and the open position 9 by means of the ejection device 18. Between the open position 9 and the closed position 4, the door arrangement 3 can be moved by the hinge force accumulator 30.

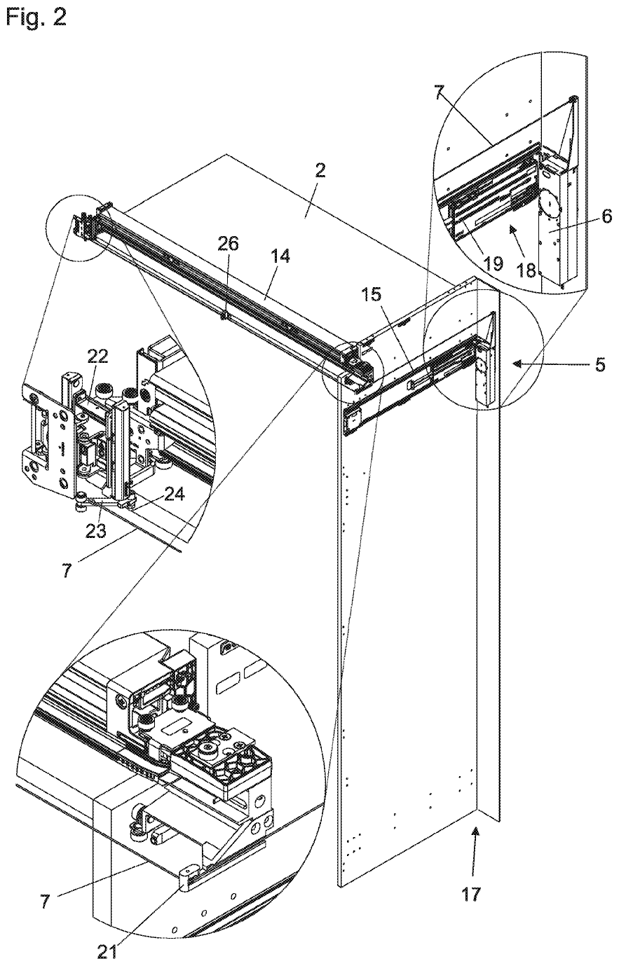

FIG. 2 shows component parts of the piece of furniture 1 which, according to this embodiment, are used to move the door arrangement 3. In this embodiment, the rope drive device 5 comprises an electric drive device 6 and a rope 7 which can be acted upon with a force by the drive device 6, wherein the rope 7 is arranged on the carriage 22 of the door arrangement 3 in such a way that the door arrangement 3 can be moved via the rope drive device 5 from the closed position 4 or a partial open position 8 in the direction of the open position 9 up to the open position 9.

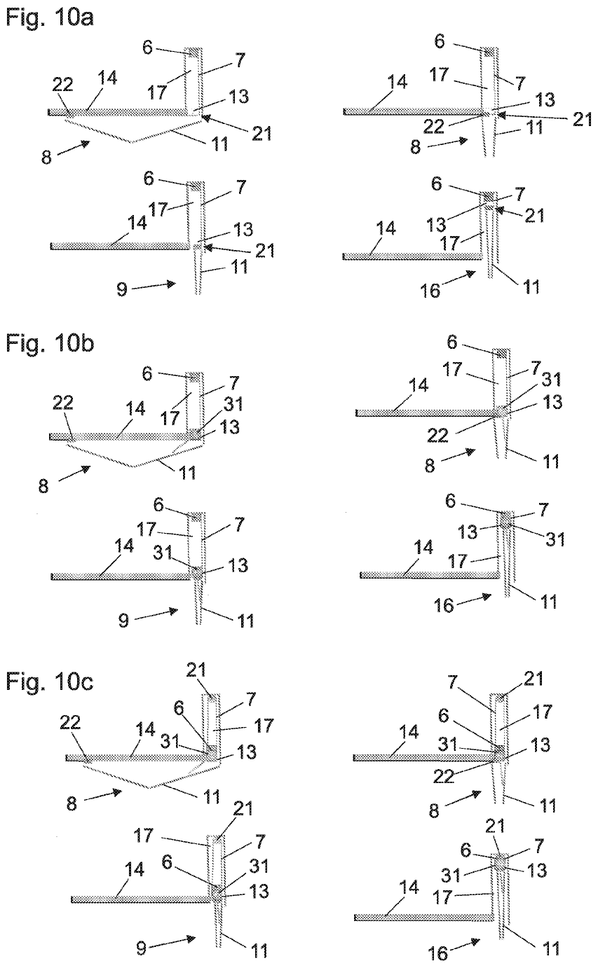

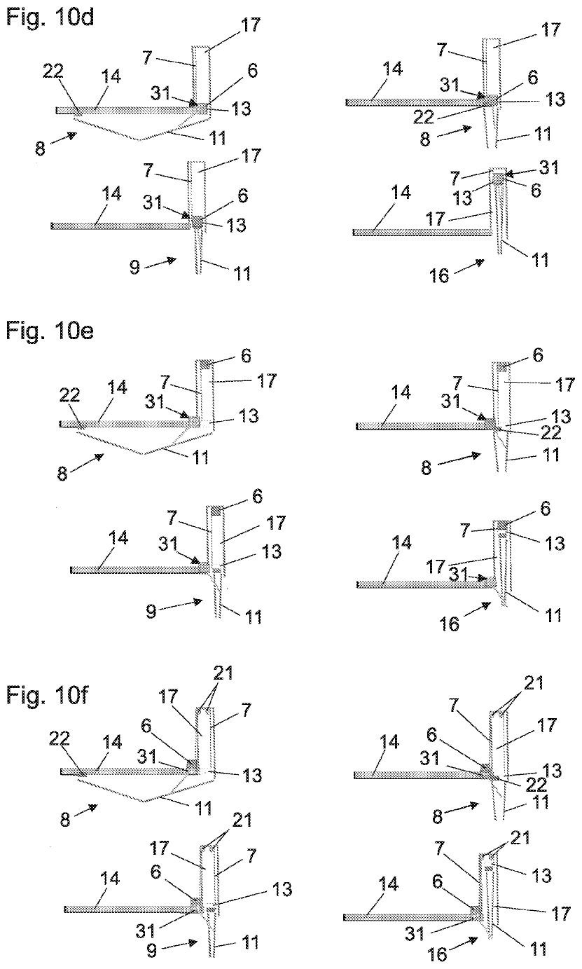

The drive device 6 is arranged stationary in a rear region of the receiving shaft 17 within the receiving shaft 17. The drive device 6 is arranged on a rear wall of the receiving shaft 17 and the longitudinal extent of the drive device 6 is oriented in a vertical direction. The rope extends from the drive device 6 to the carriage 22, which is arranged on the first guide rail 14 so as to be movable between the open position 9 and the closed position 4. Alternatively or additionally, the drive device 6—for example, the rope drive device 5 or another movement mechanism—can be provided in a movement-coupled manner with a support 13 for supporting the door arrangement 3 on a guide device, as can be seen, for example, from the embodiments according to FIG. 10c and FIG. 10d.

A support 13 of the door arrangement 3, which is hidden in the illustration for the sake of clarity, is translationally movable laterally next to the furniture body 2 along a second guide rail 15 arranged orthogonally to the first guide rail 14 between the open position 9 and the retracted position 16.

The piece of furniture 1 includes the receiving shaft 17 defined laterally next to the furniture body 2 by two vertically aligned furniture panels for receiving the at least one door arrangement 3 in a retracted position 16.

Within the receiving shaft 17, an ejection device 18 is provided for ejecting the door arrangement 3 in the direction of the open position 9, wherein an ejection force accumulator 19 of the ejection device 18 can be loaded by the movement of the door arrangement 3 in the direction of the retracted position 16 mediated by the rope drive device 5.

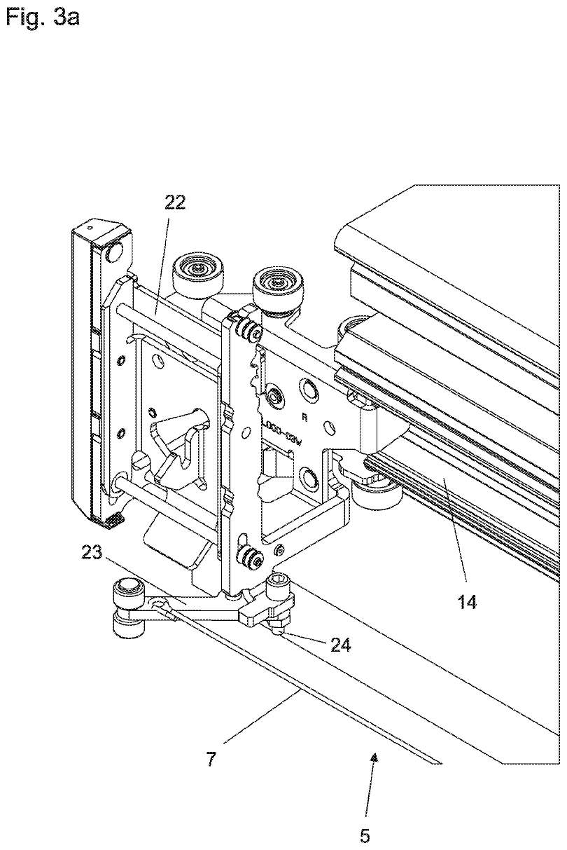

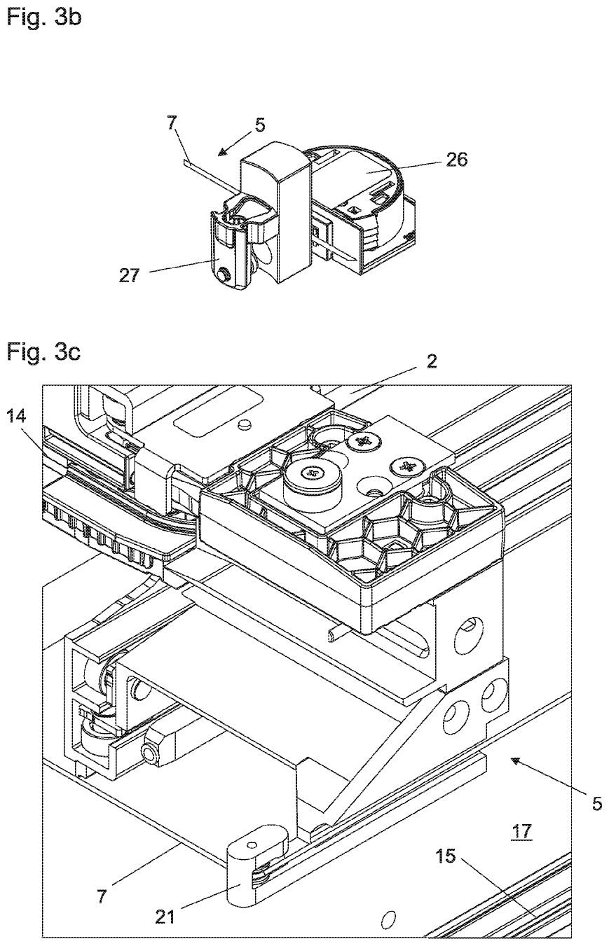

FIG. 3a shows an enlarged view of the connection of the carriage 22 for the movement of the door arrangement 3 parallel to a front of the piece of furniture 1, showing that the rope 7 is arranged on the carriage 22.

The carriage 22 comprises a pivot lever 23, wherein the pivot lever 23 is pivotably arranged on the carriage 22 and can be brought into contact with the door arrangement 3 in order to initiate or at least support an unfolding or spreading process of the door arrangement 3. The pivot lever 23 is preferably provided, but is generally not absolutely necessary and can, for example, be replaced by an ejection device to bridge a dead center position of the door arrangement 3 in the closed position, wherein the rope 7, for example, engages the base body of the carriage 22 and the ejection device is activated via radio switch or by means of an overpressure movement.

The rope 7 is arranged on the pivot lever 23. A pivoting movement of the pivot lever 23 is limited by the carriage 22 by a stop 24 arranged on the carriage 22.

FIG. 3b shows a switch 26 for activating the rope drive device 5 to start the movement of the door arrangement 3. The switch 26 can be connected to the drive device 6 by cable or by radio signal transmission. The switch 26 is preferably arranged on a front of the furniture body 2 in order to be actuated via the door arrangement 3, wherein manual actuation of the switch 26 at another position of the piece of furniture 2 is also conceivable.

The actuation of switch 26 is generally arbitrary. For example, the switch 26 can be actuated by contact, via an overpressure movement of the door arrangement 3, capacitively or inductively, etc. The actuation of the switch 26 can, for example, be effected by a hinge 27, which is actively or passively involved in transferring the door arrangement 3 into the closed position 4, although this is not absolutely necessary. The switch 26 can, for example, be located on or in a horizontal furniture panel such as a furniture top.

The hinge 27—preferably made of metal and arranged on two door leaves—comprises the contacting means for the switch 26 visualized in the illustration, wherein the contacting means is preferably made of plastic and is provided for securing the position of the door arrangement 3 in the closed position 4 with a coplanar alignment of the door leaves.

FIG. 3c shows the deflection of the rope 7 around a vertical edge of the furniture body 2, wherein a deflection device 21 for the rope 7 is arranged on the furniture body 2—attached to the first guide rail 14. The rope is deflected by a pulley, substantially by 90°.

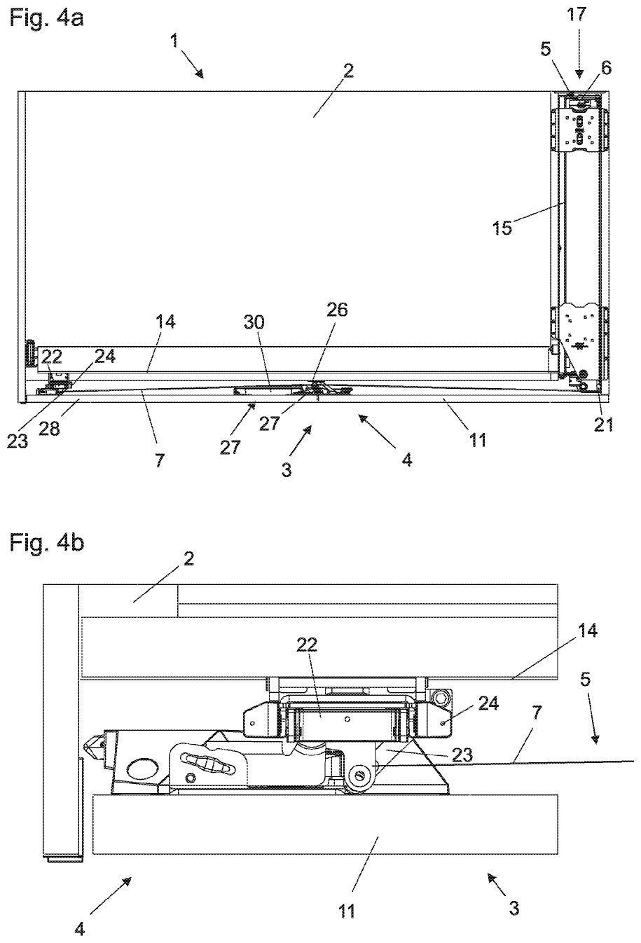

FIGS. 4a to 6b visualize a preferred movement of the door arrangement 3 in the form of the folding sliding door 11 by the rope drive device 5, wherein an exemplary method for moving the door arrangement 3 of the piece of furniture 1 by the rope drive device 5 with rope 7 coupled to the door arrangement 3 can be exemplified as follows: The door arrangement 3 is moved by the rope drive device 5 starting from the closed position 4 or the partial open position 8 in the direction of the open position 9 up to the open position 9, and starting from the open position 9 or the partially retracted position in the direction of the retracted position 16 up to the retracted position 16, or starting from the retracted position 16 or the partially retracted position in the direction of the open position 9 up to the open position 9, and starting from the open position 9 or the partial open position 8 in the direction of the closed position 4 up to the closed position 4.

The rope drive device 5 can cover the entire travel distance of the door arrangement 3, although this is generally not necessary and, for example, only an unfolding operation of the folding sliding door 11 or an unfolding operation 10 of a hinged door may be provided.

In FIG. 4a the folding sliding door 11 is in the closed position 4 and can be fully unfolded and retracted into the receiving shaft 17 during the movement process by the rope drive device 5.

The folding sliding door 11 comprises, on the one hand, hinges 27, which connect the door leaves 28 of the folding sliding door 11 to each other by means of a symmetrical arrangement on the door leaves 28 and which in the closed position 4 or an overpressure position is arranged on the rope 7 in such a way that a pretension can be transferred to the rope 7.

On the other hand, the folding sliding door 11 comprises another hinge 27, which is also arranged on both door leaves 28 and can support or carry out the movement of the folding sliding door 11 into the closed position 4.

The further hinge 27 comprises a hinge force accumulator 30 to support the movement of the door arrangement 3 in the direction of the closed position 4, wherein the hinge force accumulator 30 can be loaded by the movement of the door arrangement 3 in the direction of the open position 9 mediated via the rope drive device 5.

The hinge 27 or the additional hinge 27 can be used to actuate the switch 26 in the overpressure position.

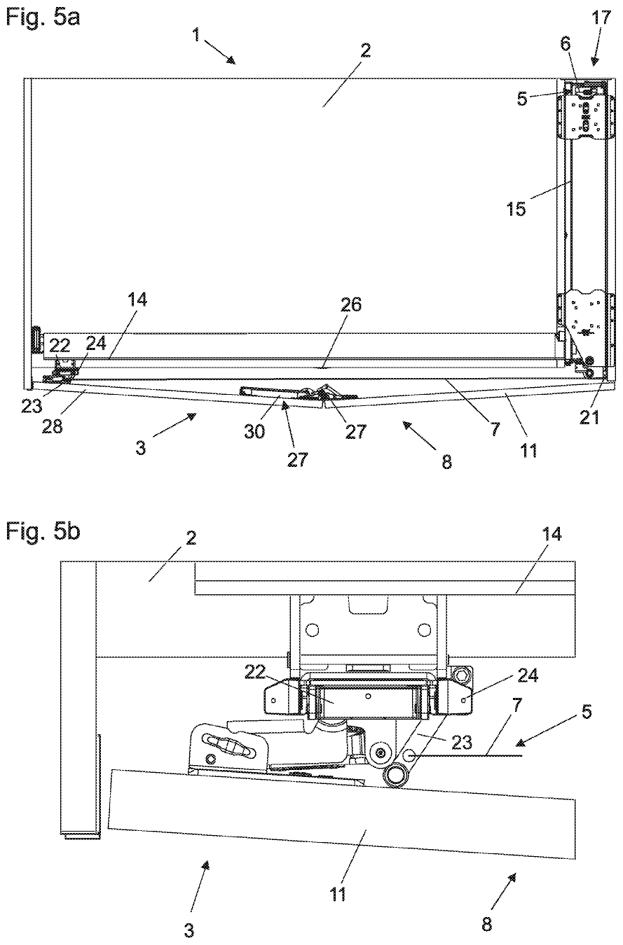

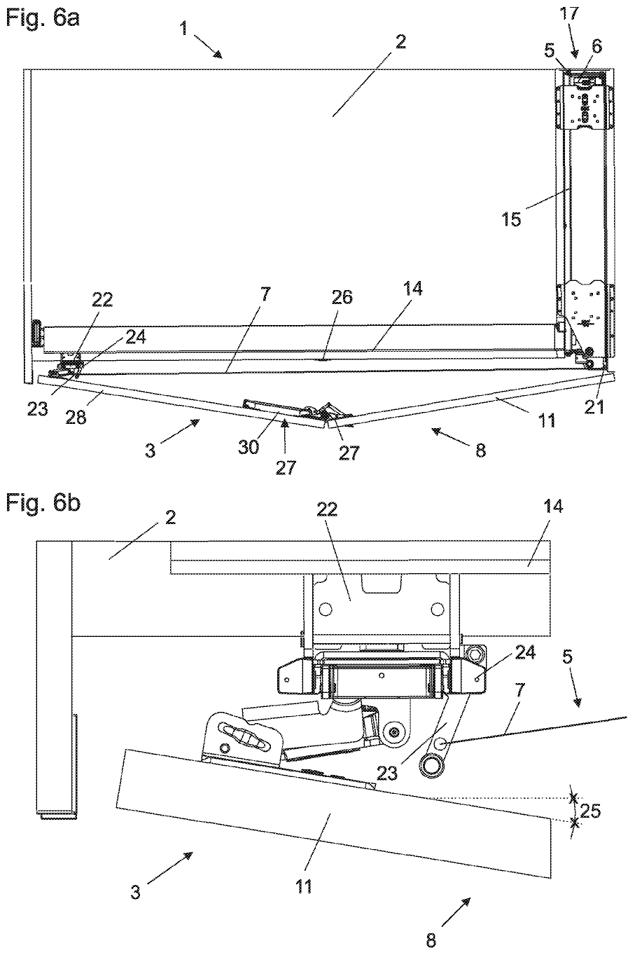

Starting from the door arrangement 3 in the closed position 4 in FIG. 4a and FIG. 4b, in this embodiment the pivot lever 23 of the carriage 22 is pivoted by the rope 7 according to FIG. 5a and FIG. 5b and the carriage 22 initially remains stationary on the first guide rail 14, wherein the pivot lever 23 partially opens the folding sliding door 11 and then separates it from the folding sliding door 11 according to FIG. 6a and FIG. 6b, wherein the pivot lever 23 is moved translationally in the direction of the open position 9 along the first guide rail 14 by means of the rope 7 in a movement-coupled manner with the carriage 22.

In FIG. 6b, the pivot lever 23 is already against the stop 24 to limit the pivoting movement and has been released from the door arrangement 3 at a door arrangement opening angle 25 of about 6° (15 ° is preferred).

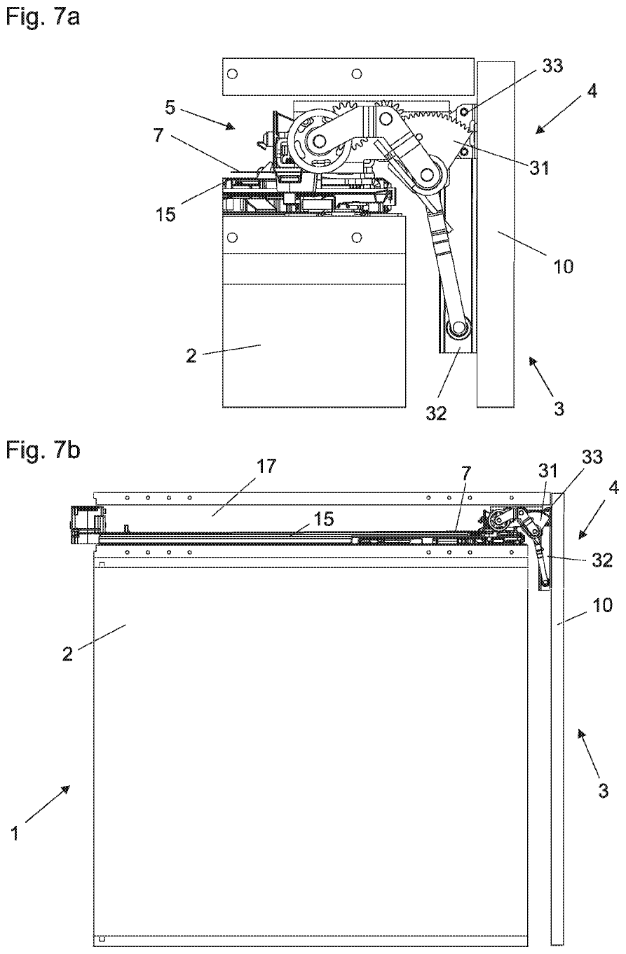

FIG. 7a and FIG. 7b show a piece of furniture 1 in which a hinged door 10 is attached to the door arrangement 3. The hinged door 10 is in the closed position 4.

The rope 7 of the rope drive device 5 engages a coupling gear 31, wherein the coupling gear 31 transmits a movement to the door arrangement 3 in the direction of the open position 9 or vice versa via a force application by the rope drive device 5.

In this embodiment, the rope drive device 5 can be located in the rear region of the receiving shaft 17 or coupled to the movement of the door arrangement 3, for example the support 13.

Preferably, the electric drive device 6 is mounted on the support 13.

Through the transmission of force from the rope of the rope drive device 5 to the coupling gear 31, the door arrangement—mediated by the coupling gear 31—can be moved from the open position 9 or the partial open position 8 in the direction of the closed position 4 until it reaches the closed position 4.

The number of rope drive devices 5 is generally arbitrary. For example, a rope drive device 5 can be provided for a movement of the door arrangement 3 in the closing direction and another rope drive device 5 for a movement of the door arrangement 3 in the opening device, wherein one of the two directions of movement can alternatively or additionally be taken over, for example, by a force accumulator.

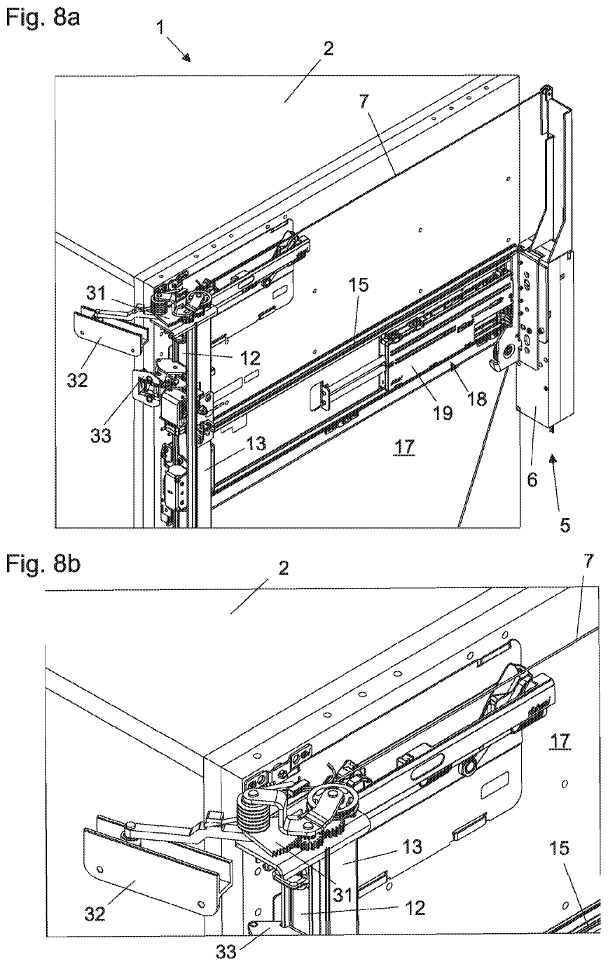

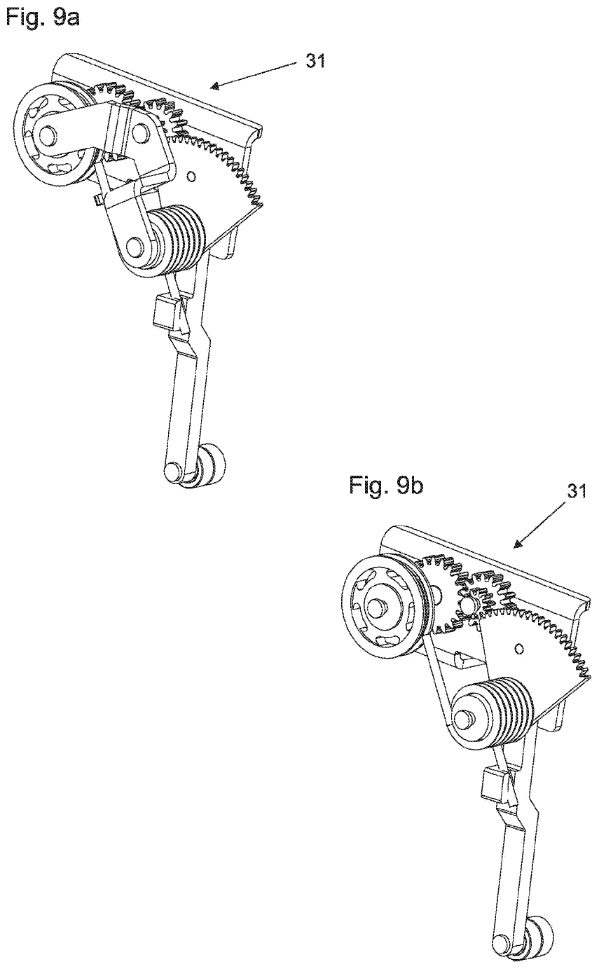

FIG. 8a and FIG. 8b in enlarged view show the coupling gear 31 in connection with the rope 7 of the rope drive device 5.

The coupling gear 31 is arranged on the support 13 and is connected to the (hidden in the illustrations) door arrangement 3. In general, the coupling gear 31 can also transmit a rotation of the door arrangement 3 at the hinge band 12, which acts as a link between the support 13 and the door arrangement 3. For example, the coupling gear 31 can transfer force from the rope drive device 5 to the door arrangement 3 by transferring force to a support hinge 33.

The coupling gear 31 of this embodiment comprises a profile rail 32, via which the coupling gear 31 is arranged on the door arrangement 3 for the transmission of a tensile and/or compressive force to the door arrangement 3. In general, the coupling gear 31—acting as an intermediate link between the door arrangement 3 and the rope drive device 5—can act directly on the support hinge 33.

The rope 7 is arranged on the coupling gear 31, which is spatially separate from the drive device 6.

FIGS. 10a to 10f show embodiments with a folding sliding door 11, wherein the folding sliding door 11 in the embodiments in FIGS. 10b to 10f can be replaced by a hinged door 10 (without coupling with the carriage 22) or a folding door (without coupling with the carriage 22). The hinged door 10, the folding door or the folding sliding door 11 is connected to the support 13 at one end.

FIG. 10a shows parts of the piece of furniture 1, wherein the drive device 6 of the rope drive device 5 is arranged at the rear in the receiving shaft 17 and the rope 7 is connected to the carriage 22 of the folding sliding door 11 of the door arrangement 3.

Starting from a closed position 4 or the partial open position 8 shown at the top left, the folding sliding door 11 is continuously unfolded by the rope drive device 5 in the direction of the open position 9 shown at the bottom left (corresponds to folding close the door leaves 18 of the door arrangement 3). After entering the open position 9, the folding sliding door 11 is moved by the rope drive device 5 into the retracted position 16 in the receiving shaft 17.

In general, a mechanical device for moving the door arrangement 3 into the open position 9 and/or into the retracted position 16—for example in the form of a recess arranged on the furniture body 2 or on a door leaf for manual operation of the door arrangement or a mechanical folding mechanism for the door arrangement 3—can be provided on the door arrangement 3 in order to ensure movement of the door arrangement 3, for example in the event of a failure of electrical drive means. The mechanical device can be provided analogously for movement to the retracted position 16 or to the closed position 4.

FIG. 10b shows parts of the piece of furniture 1, wherein the drive device 6 of the rope drive device 5 is arranged at the rear in the receiving shaft 17 and the rope 7 is coupled to a coupling gear 31, which, by applying force via the drive device 6, ensures a pivoting movement of the folding sliding door 11 (or the hinged door 10 or folding door) in the direction of the closed position 4 or the open position 9.

The coupling gear 31 is arranged on the support 13 and can, for example, interact with a pivoting arm on a support hinge 33 for—possibly indirect—connection via a hinge band 12,
of the folding sliding door 11 to the support 13.

A second rope drive device 5 can be provided for bidirectional movement of the folding sliding door 11 between the closed position 4 and the open position 9.

FIG. 10c shows parts of the piece of furniture 1, wherein the drive device 6 of the rope drive device 5 is arranged on the support 13 and is connected via the rope 7 to the coupling gear 31 for pivoting the folding sliding door 11.

The rope 7 is guided in a loop shape via a deflection device 21 in the form of a deflection pulley arranged—on the rear side—in the receiving shaft 17, so that a movement of the folding sliding door 11 in the direction of the closed position 4 as well as in the direction of the open position 9 can be mediated via the same rope 7.

FIG. 10d shows parts of the piece of furniture 1, wherein the drive device 6 of the rope drive device 5 is arranged on the support 13, with one end of the rope 7 (at the rear) being attached to the receiving shaft 17.

The drive device 6 drives the coupling gear 31 to pivot the door arrangement 3, wherein the support 13 is moved via the rope 7 in the direction of the retracted position 16.

FIG. 10e shows parts of the piece of furniture 1, wherein the drive device 6 of the rope drive device 5 provides for the retraction movement of the support 13 and the coupling gear 31 for the pivoting operation is arranged on the first guide rail 14, wherein the coupling gear 31 can generally also be arranged in another position on the furniture body 2 or the receiving shaft 17.

FIG. 10f shows parts of the piece of furniture 1, wherein the drive device 6 of the rope drive device 5 is arranged on the furniture body 2 or the first guide rail 14.

The rope 7 is guided over a deflection device 21 in the form of two deflection pulleys 21 (the number is generally arbitrary) and is coupled to the support 13 of the door arrangement 3.

The drive device 6 is operatively connected to the coupling gear 31, which pivots the door arrangement 3.

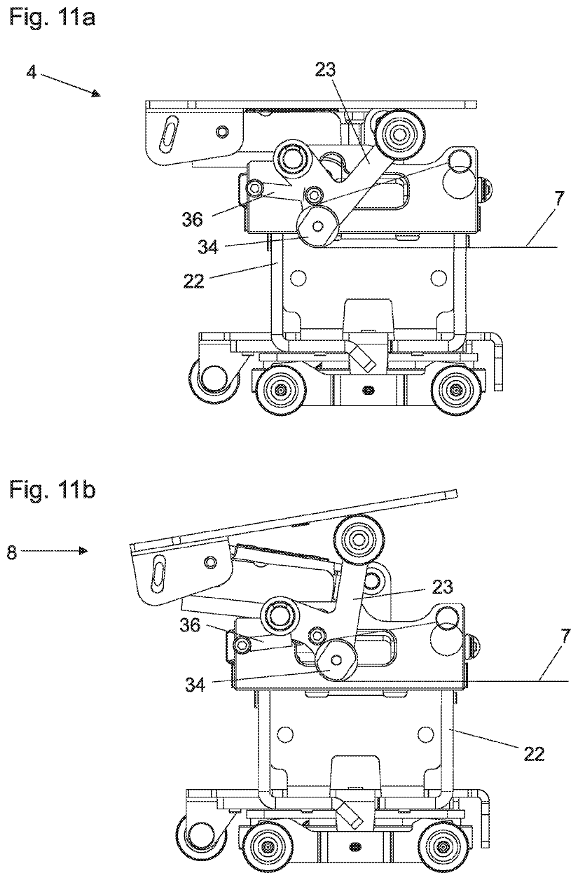

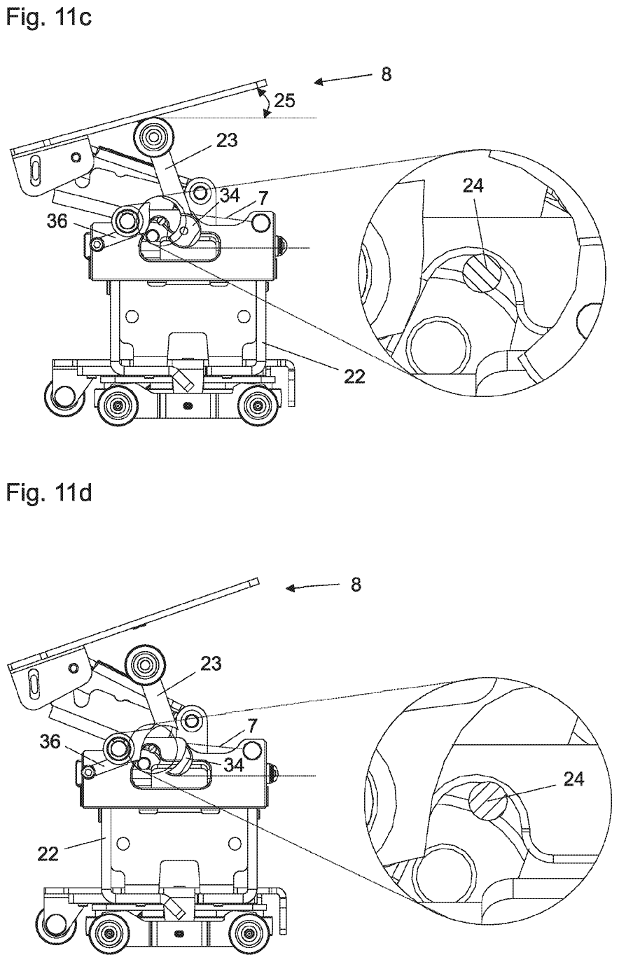

FIG. 11a and FIG. 11b show that the rope drive device 5 comprises a pulley 34 for reducing a force acting on the door arrangement 3 from a rope 7. In general, the positioning of the pulley 34, the number of deflections of the rope 7 on the pulley 34, and the number of pulleys 34 are arbitrary.

In FIG. 11a, the door arrangement 3 is in the closed position 4. In FIG. 11b, the door arrangement 3 was bent into the partial open position 8 by the pivot lever 23. The pivot lever 23 includes a force accumulator 36, with which the pivot lever 23 can be returned to the initial position according to FIG. 11a.

FIGS. 11c and 11d show that in this embodiment of the carriage 22 a stop 24 is provided which can be brought into contact with an opening of the carriage 22 to limit the pivoting movement of the pivot lever 23. In general, contacting the stop 24 on an outer contour of the carriage 22 is possible—for example, according to the exemplary embodiment shown in FIG. 3a.

In the position of the carriage 22 shown in FIG. 11c, the door arrangement opening angle 25 is approximately 15 degrees, at which the pivot lever according to FIG. 11 d detaches from the door arrangement 3.

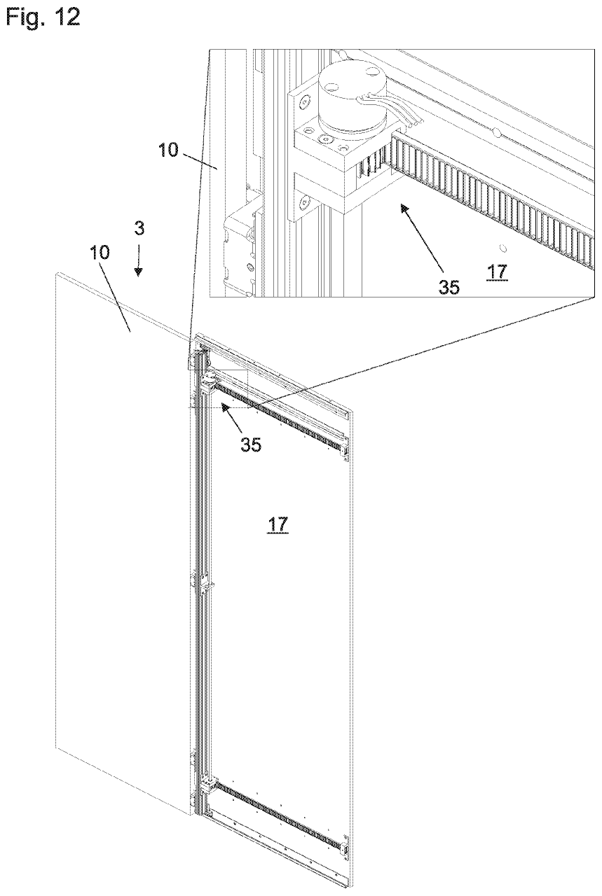

FIG. 12 shows a movement device 35 for the movement of the door arrangement 3 relative to the receiving shaft 17, wherein the movement device 35 can act alternatively or in addition to the rope drive device 5. The movement device 35 comprises a rack interacting with an electrically driven gear, wherein the gear may, for example, form part of the coupling gear 31 or be provided separately from the coupling gear 31. The door arrangement 3 is in the form of a hinged door 10, wherein a door arrangement 3 can also be designed as a folding sliding door 11. The movement device 35 can be provided for moving the door arrangement 3 from the retracted position 16 towards the open position 9. The movement device 35 can be provided for moving the door arrangement 3 from the open position 9 towards the retracted position 16.

In general, as an alternative or in addition to the mechanical drive devices described so far, the mechanical drive device can be in the form of
a mechanical rope drive device, which is preferably arranged within the receiving shaft 17 or supports or accomplishes an extension movement of the door arrangement 3 from the receiving shaft 17
a force accumulator mounted on the door arrangement 3, preferably on two door leaves, and which can be activated by moving the door arrangement 3 from the closed position 4 into an overpressure position, for moving the door arrangement in the direction of the open position 9, which is preferably designed to move the door arrangement 3 from the open position 9 in the direction of the closed position 4
a spring device with which the door leaf or door leaves of the door arrangement 3 can be subjected to force in the direction of a substantially parallel alignment relative to the receiving shaft 17 (or is or are held in this alignment), wherein the spring device for the door arrangement 3 preferably has a dead center position in the transition to the substantially parallel alignment or interacts with the release of the carriage 22 in the direction of the retracted position 16

In general, at least one damping device, preferably as a separate component or in interaction with a mechanical drive device, can be provided for the movement of the door arrangement 3, which dampens, for example, the entry into the closed position 4, the open position 9 (essentially parallel alignment of the door arrangement 3 with respect to the receiving shaft 17 from the closed position 4 or the retracted position 16) or the retracted position 16. For example, the damping device can be arranged in the receiving shaft 17 or on the mechanical drive device (such as the hinge force accumulator 30).

1. A piece of furniture comprising:
a furniture body,
at least one door arrangement, comprising a hinged door, that is preferably pivotable about an axis that is vertical in the operating position of the piece of furniture, a folding door and/or a folding sliding door, for at least partially covering the furniture body, preferably an interior space of the furniture body defined by the furniture body, in a closed position of the at least one door arrangement,
a receiving shaft arranged laterally of the furniture body, within which the at least one door arrangement can be moved, at least in regions, into a retracted position,
at least one electric drive device for applying force to the at least one door arrangement, wherein the at least one door arrangement is movable by the at least one electric drive device at least in regions between a closed position and an open position and/or between an open position and a retracted position in the receiving shaft, and
at least one mechanical drive device, preferably an ejection device for ejecting the at least one door arrangement from the receiving shaft and/or a hinge force accumulator for spreading the folding door and/or folding-sliding door, wherein the at least one door arrangement is movable by the at least one mechanical drive device at least in regions between the closed position and the open position and/or between the open position and the retracted position,
wherein the at least one electric drive device and the at least one mechanical drive device are arranged, at least in the retracted position, between two planes spanned by the receiving shaft and oriented parallel to a side wall of the furniture body, preferably within the receiving shaft.

2. The piece of furniture according to claim 1, wherein the piece of furniture comprises at least one rope drive device, wherein the at least one rope drive device comprises the at least one drive device and at least one rope that can be tensioned by a force by the at least one drive device, wherein the at least one rope is arranged or can be arranged on the at least one door arrangement in such a way that the at least one door arrangement is movable via the at least one rope drive device.

3. The piece of furniture according to claim 1, wherein the hinged door, folding door and/or folding sliding door is preferably mounted via a hinge strip on a support and/or at least one carriage of the at least one door arrangement, wherein it is preferably provided that the at least one carriage moves along a first guide rail between the open position and the closed position and/or the support is movable in a translational manner along a second guide rail, preferably arranged orthogonally to the first guide rail, between the open position and a retracted position laterally adjacent to the furniture body.

4. The piece of furniture according to claim 1, wherein the receiving shaft comprises at least one ejection device for ejecting the at least one door arrangement in the direction of the open position, wherein an ejection force accumulator of the at least one ejection device can be loaded by the movement of the at least one door arrangement in the direction of the retracted position mediated by the at least one electrical drive device.

5. The piece of furniture according to claim 1, wherein the at least one drive device is arranged stationary, preferably in a rear region of the receiving shaft, within the receiving shaft and/or is coupled to the movement of the at least one door arrangement, preferably a support that may be present.

6. The piece of furniture according to claim 1, wherein the at least one door arrangement is movable via the at least one electric drive device:
starting from an open position or a partially retracted position in the direction of a retracted position, preferably up to the retracted position, and/or
starting from the retracted position or the partially retracted position in the direction of the open position, preferably up to the open position.

7. The piece of furniture according to claim 2, wherein at least one deflection device for the at least one rope is arranged on the furniture body, preferably on a guide rail that may be present, and/or in the receiving shaft.

8. The piece of furniture according to claim 2, wherein the at least one rope is arranged on the at least one carriage and/or the at least one carriage comprises at least one pivot lever, wherein the at least one pivot lever is pivotably arranged on the at least one carriage and can be brought into contact with the at least one door arrangement.

9. The piece of furniture according to claim 8, wherein the at least one rope is arranged on the at least one pivot lever, wherein it is preferably provided that a pivoting movement of the at least one pivot lever is limited by the at least one carriage, preferably a stop arranged on the at least one carriage and/or to a door arrangement opening angle in the range between 5° and 15°.

10. The piece of furniture according to claim 1, wherein the at least one drive device can be activated by a switch preferably arranged on the furniture body or on the at least one door arrangement, preferably by a pressing motion of the at least one door arrangement located in the closed position and/or by contact or capacitively.

11. The piece of furniture according to claim 1, wherein the at least one door arrangement can be fully unfolded and/or folded or opened and/or closed by the at least one electric drive device between the closed position and the open position and/or can be folded open and/or closed and/or can be swung open and/or swung closed and/or the at least one door arrangement comprises a folding door and/or folding sliding door, wherein the folding door and/or folding sliding door comprises a hinge, wherein the hinge connects door leaves of the folding door or folding sliding door to one another and which comprises a hinge force accumulator for assisting a movement of the at least one door arrangement toward the closed position, wherein the hinge force accumulator can be loaded by the movement of the at least one door arrangement toward the open position mediated by the at least one electric drive device.

12. The piece of furniture according to claim 1, wherein the at least one electric drive device is arranged on at least one coupling gear spatially separate from the at least one electric drive device.

13. The piece of furniture according to claim 3, wherein the at least one electric drive device is arranged by the at least one coupling gear, preferably via a profile rail arranged on the at least one door arrangement, on the at least one door arrangement and/or the support, preferably the hinge band, and/or at least one support hinge.

14. The piece of furniture according to claim 2, wherein the at least one rope drive device comprises at least one pulley for reducing a force acting from the at least one rope on the at least one door arrangement.
